(19) United States
(12) Patent Application Publication
(10) Pub. No.: US 2005/0079038 A1
(43) Pub. Date: Apr. 14, 2005

(54) Tire lift, storage and transporter

(75) Inventors: James Vlaanderen, Kremme, IA (US); Thomas M. Frederick, Forest City, IA (US)

Correspondence Address: WOOD, PHILLIPS, KATZ, CLARK & MORTIMER, 500 W. MADISON STREET, SUITE 3800, CHICAGO, IL, 60661, US

(73) Assignee: Stellar Industries Inc.

(21) Appl. No.: 10/684,792

(22) Filed: Oct. 14, 2003

(51) Int. Cl. B62B 1/00

(52) U.S. Cl. 414/470

(57) ABSTRACT

A transporter and storage and lift unit, particular suited for tires includes an elongated vehicle frame capable of traveling over the underlying terrain includes a plurality of elongated object supports. Pairs of parallelogram linkages are provided for each of the object supports so as to mount them for movement between transport and/or storage positions overlying the frame and positions substantially engaging the underlying terrain for the addition of or removal of tire to or from the supports.

### FIELD OF THE INVENTION

This invention relates to apparatus for storing and transporting articles, most notably vehicular tires.

### BACKGROUND OF THE INVENTION

The overwhelming majority of vehicles in use today employ tires as grounding engaging elements by which the vehicle may traverse the underlying terrain. As fully expected, the tires require periodic replacement and/or servicing.

In many locales, tire replacement and servicing facilities are separated by very large distances, making it difficult to achieve access to the facility for tire replacement and/or servicing. This is all the more true where a vehicle develops tire problems in a remote location and as a consequence of the tire problem, cannot be moved to a tire replacement or maintenance facility.

Consequently, many tire dealers employ a fleet of service vehicles that may be utilized for replacing and/or maintaining tires by driving from a central location to the location of the vehicle whose tires must be replaced and/or serviced. These types of operation are quite common in agricultural areas, mining areas, and the like.

Furthermore, with the large variety of tires around as well as the fact that a number of relatively specialized vehicles utilizing tire require tire maintenance from time to time and may require tires of somewhat unusual sizes, it is not always practical for a multi-location tire servicing operation to maintain an inventory of all possible tires that might be required by its customers at each of its locations. Such an operation may keep a few sizes of tires at one location and completely different sizes at another. When the need arises, the tires may be moved from the location having them and placed in inventory at the location that does not when the latter is servicing a tire of a particular size.

While many, relatively small tires do not present a particular handling problem to an experienced tire maintenance person, larger tire sizes are heavy and frequently difficult to manipulate. This job becomes even more difficult where tires must be handled in remote locations such as an agricultural field or the like.

Service vehicles heretofore known can accomplish these various tasks when used by a skilled operator but not without some difficulty. For example, a service vehicle may be equipped with a small crane for moving tires to and from the bed of the vehicle and which also may be used during a servicing operation. This requires the loading or unloading of the tires one at a time and may require multiple personnel, one to help guide the tire as it is being loaded and unloaded and another to operate the crane. Similarly, such a vehicle may have limited tire carrying capacity and consequently cannot serve as a storage space for storing tires as part of an inventory that is sufficiently varied so as to be useful in accomplishing several servicing jobs in one trip, all on vehicles having different size tires.

Thus, there is a real need for a vehicle in the form of a truck or trailer for holding or storing a large variety of tires while additionally having the capability of carrying the tires to and from desired locations while allowing the operator to lower the tires to the ground for easy handling.

### SUMMARY OF THE INVENTION

It is the principal object of the invention to provide a new and improved storage and transporter apparatus. More specifically, it is an object of the invention to provide a new and improved tire lift, storage and transporter apparatus that may be incorporated into a vehicle such as a truck or a trailer. It is also an object of the invention to provide a lift and storage device for a variety of goods that may be useful in applications where a transportation mode of operation is not required.

An exemplary embodiment achieves the first of these objects in a transporter and storage unit which includes an elongated vehicle frame having a front and rear interconnected by elongated opposite sides. Ground engaging means are located on the frame whereby the frame may traverse the underlining terrain and at least two movably elongated object supports extend forwardly from the rear on at least one of the sides above the frame. The object supports are movable between positions overlying the frame and positions substantially engaging the underlying terrain. A pair of parallelogram linkages are provided for each of the object supports. Each parallelogram linkage has long links and short links and has pivots at corresponding ends of the links which interconnect the same. A first two of the pivots of each linkage of each pair is pivoted to a part of the frame defining one of the short links or to a short link joined to the frame. The first two pivots for the linkages of each pair are aligned with one another. A second two of the pivots of each linkage of each pair are pivoted to a part of a corresponding one of the object support which define a second one of the short links or to a short link joined to the object support. The second two pivots for the linkage of each pair are aligned with one another.

In a preferred embodiment, the foregoing structure contemplates that both of the object supports are located to the same side of the frame and the long links of one of the pairs are longer than the long links of the other of the pairs.

In an alternative embodiment, one of the object supports is located to one of the opposite sides and the other of the object supports is located to the other of the opposite sides.

A preferred embodiment contemplates the use of extendable motors, one for each linkage, which extend generally between opposite ones of one the first two pivots and one of the second two pivots.

The invention also contemplates the use of an object support rests on the frame which are engageable by the object supports when the object supports are in a position overlying the frame.

A highly preferred embodiment contemplates that there should be four objects support, two located to one of the opposite sides and two located to the other of the opposite sides of the frame.

One embodiment contemplates that the two object supports on each of the sides are vertically separated with one being higher on the frame than the other when both are in the positions overlying the frame.

In such an embodiment, it is preferred that the lowermost ones of the object supports be shorter than the uppermost ones of the object supports and that each pair of linkages includes a linkage located at each end of the corresponding object supports. The first two pivots of one linkage are shared by the other linkage at the corresponding ends of the object supports located to the same side of the frame.

A highly preferred embodiment of the invention contemplates that the long links of the pair of linkages connected to the uppermost object supports when the object supports are overlying the frame be longer than the long links of the pair of linkages connected to the lowermost object support when the object supports are overlying the frame.

In a preferred embodiment, the extendable motors are extendable fluid motors.

In a preferred embodiment, each object supports includes an end plate at each end thereof and each such end plate defines a short link to which the second two pivots are attached.

In one embodiment, each object supports includes a plurality of bars extending between its end plates and defining a support for articles to be transported or stored.

According to another aspect of the invention, an apparatus is provided that includes a frame having two spaced cross members connected to one another by at least one elongated stringer. The elongated stringer has an upper, relatively low support surface. A generally centrally located upright element extends upwardly from each of the cross members and terminates at an upper, relatively high support surface. A plurality of parallelogram linkages, each having two relatively short links with four first linkages having relatively long links and four second linkages having intermediate length links to provide four linkages having the relatively long links connected by pivots to their ends to the relatively short links and four linkages having the intermediate length link linkages connected by pivots to the relatively short links to respectively form first and second linkages. Each of the cross members mounts one of the first linkages and one of the second linkages on each side of the upright element at one of the relatively short links with the first linkages being outermost and the second linkages being innermost. Four cradles each have spaced end plates connected by at least one support member with the end plates defining one of the relatively short links. Stub shafts extend from the end plates to define those of the pivots connecting the relatively long links and the intermediate length links to the short links defined by the end plates. The relatively long links have lengths so that the cradles mounted to the first linkages which are movable between positions substantially engaged with the terrain underlying the frame and resting on the relatively high support surfaces. The intermediate length links have a length so that cradles mounted to the second linkages are movable between positions substantially engaged with terrain underlying the frame and resting on the relatively low support surfaces. Motors are provided for independently moving the cradles between the positions.

In a preferred embodiment, the relatively long lengths and intermediate length links are formed of channels which open toward each other and the motors are four cylinders extending between opposite ones of the pivots in each linkage. The cylinders are housed by the channels when the corresponding cradle is resting on its support surface.

Other object and advantages will become apparent from the following specification taken in connection with the accompanying drawings.

### DESCRIPTION OF THE DRAWINGS

FIG. 1 is a perspective view of a lift, storage and transporter apparatus made according to the invention incorporated in a truck;

FIG. 2 is a rear view or the embodiment of the invention showing all of the cradles overlying the frame;

FIG. 3 is a view similar to FIG. 2 but illustrating the cradles in a variety of different positions;

FIG. 4 is a perspective view of a frame used in the apparatus; and

FIG. 5 is a perspective view of an object support, specifically intended for supporting tires, employed in a preferred embodiment of the invention.

### DESCRIPTION OF THE PREFERRED EMBODIMENTS

While the invention will be described herein as being mounted on the frame of a self-propelled vehicle such as a truck, be understood that the invention could be employed with other vehicles as, for example, a trailer to be towed by a tractor or even a truck which may or may not also have the invention installed thereon. Furthermore, it will be appreciated that where a transporting mode of operation is not required, the invention may be employed in a stationary setting for storage and lifting purposes and usable with objects other than tires.

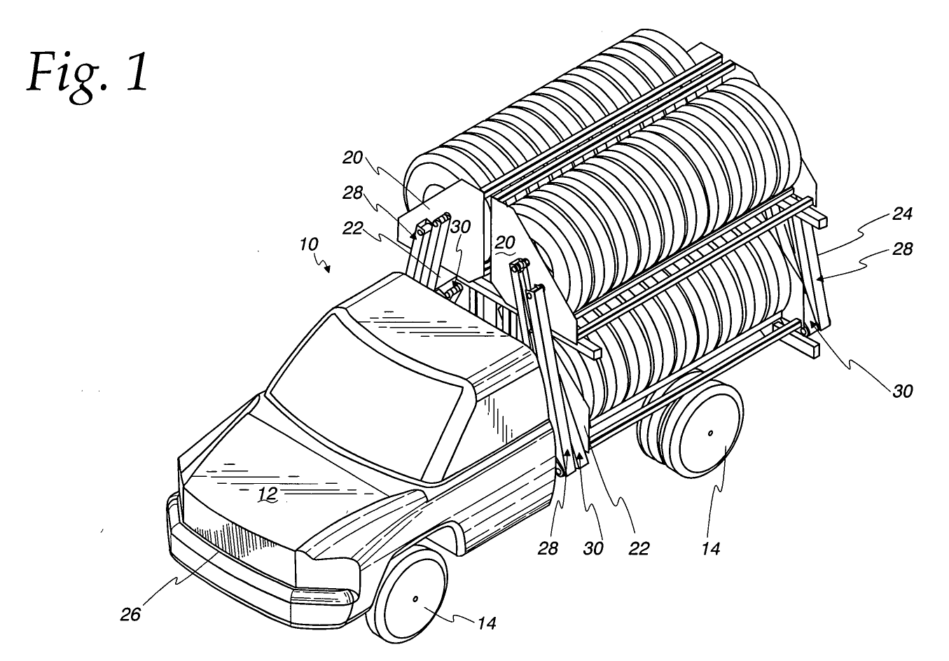

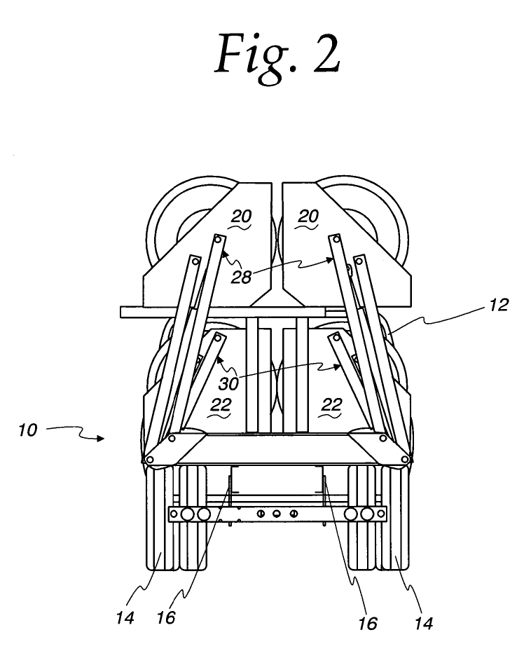

With the foregoing in mind, attention is directed to FIGS. 1 and 2 wherein a vehicle, generally designated 10, in the form of truck having a forward cab 12 and wheels 14 for engaging the underlying terrain is provided. As best seen in FIG. 2, extending rearwardly from the cab, the truck 10 includes generally parallel frame member 16 on which an embodiment of the invention is mounted. As seen in FIGS. 1 and 2, the apparatus include four cradles including two upper cradles 20 and two lower cradles 22, there being one upper cradle 20 and one lower cradle 22 on each side of the frame 16. As seen in FIG. 1, the cradles 20, 22, extend from the rear 24 of the vehicle 10 toward the front 26 of the vehicle.

The illustrated embodiment includes a total of eight parallelogram linkages including four first linkages, generally designated 28 (only three of which are shown in FIG. 1) and four second linkages, generally designated 30, only three of which are illustrated in FIG. 1. The cradles 20, 22 are elongated as will be described in greater detail hereinafter, and each cradle has a parallelogram linkage at each of its two ends. Specifically, the upper cradles 20 are connected to the first parallelogram linkages 28 while the lower cradles 22 are connected to the second linkages 30.

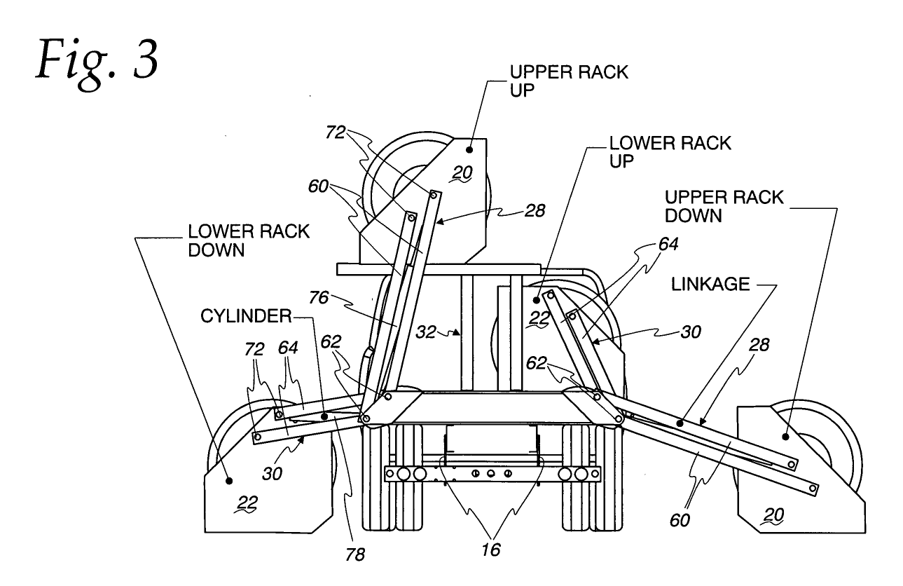

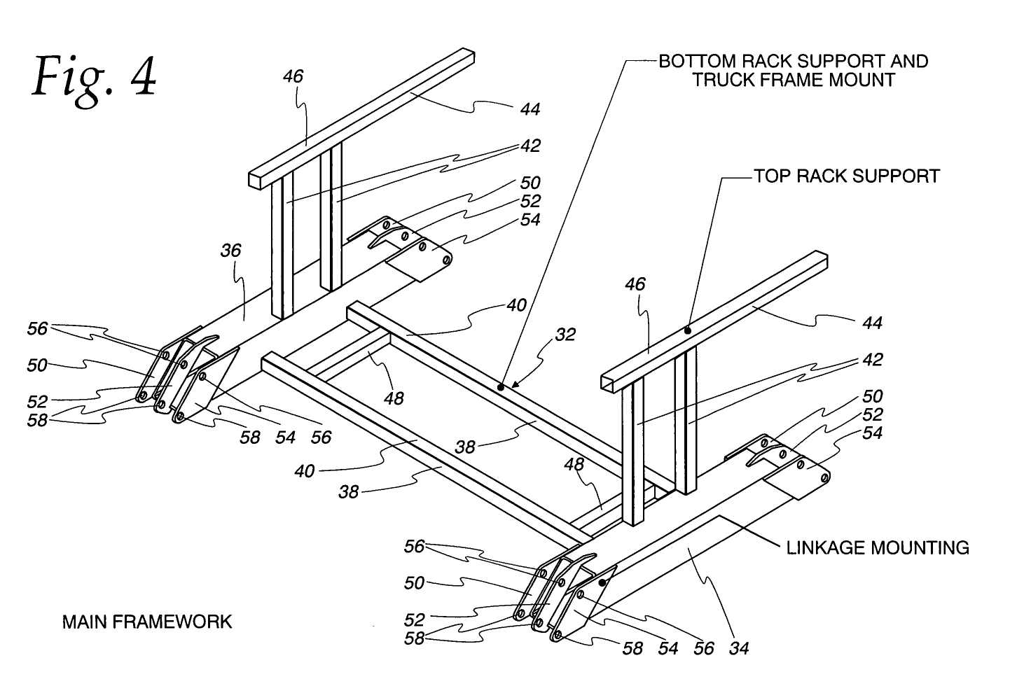

Referring to FIG. 4, a frame, generally designated 32 is provided. The frame 32 may be integral with the frame members 16 (FIGS. 2 and 3) or more preferably, for ease of manufacturing and installation, is separate therefrom but secured thereto by any suitable means (not shown). The frame 32 includes a front cross member 34 and a rear cross member 36 which are spaced from one another and extend across the length of the vehicle 10 and which are interconnected by spaced stringers 38 such as box beams. The stringers 38 each have an upper, relatively low, support surface 40 for purposes to be seen.

Generally centrally of each of the stringers 34 and 36 are a pair of box beam uprights 42 which terminate in a generally horizontal cradle support 44 having an upper, relatively high support surface 46, also for purposes to be seen.

A pair of cross members 48 extend between the stringers 38 to strengthen the same.

Each of the cross members 34, 36, at each end thereof, mounts a series of three plates 50, 52, and 54. The plates 50 are rearward most while the plates 54 are forward most and the plates 52 located between the plates 50 and 54. Each of the plates includes spaced pivot pin receiving pin apertures 56 and 58 with the apertures 56 in each series being aligned with each other and with the apertures 56 in the series on one side of the frame 32 being aligned with the apertures 56 in the plates 50, 52, 54 in the other series on the same side of the frame 32. The apertures 58 in the plates 50, 52, 54 are similarly aligned.

That part of the frame 32 defined by the plates 50, 52, 54 defines a short link for the parallelogram linkages on the same side of the frame 32 and it will be appreciated that such short links can be integrally formed with the corresponding cross member 34, 36 or may be on separate plates such as the plates 50, 52 and 54 secured to the ends of the corresponding cross member 34 or 36.

Turning now to FIGS. 2 and 3, each of the first linkages 28 is made up of two relatively long links 60 of identical length. One end of each of the links 60 is connected by appropriate pivot pins 62 to the short links defined by the plates 50, 52, 54.

The second linkages 30 are made up of two parallel, identical intermediate length links 64 which are likewise connected to corresponding one of the cross members 34, 36 by the pivot pins 62 at one end. That is to say, the pivot pins 62 at each of the short links defined by the plates 50, 52, 54, are shared by the corresponding first linkage 28 and second linkage 30 at the corresponding location.

As can be appreciated from FIGS. 2 and 3, each of the links 60 and 64 is formed of a channel and the two links 60 open toward one another as do the links 64.

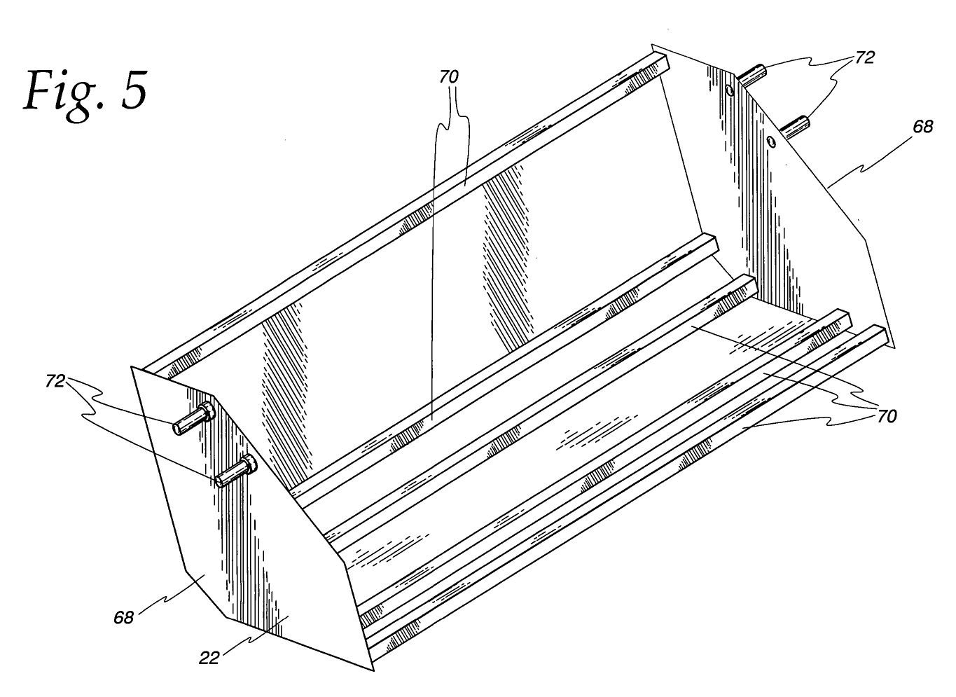

Turning to FIG. 5, one of the cradles 22 will be described in greater detail, it is being understood that both of the cradles 22 are identical one to another and are generally identical to the cradles 20 except for the length differences mentioned earlier and other small differences to be described hereinafter. Each of the cradles includes spaced, end plates 68 which are interconnected by a plurality of bars 70 to provide support for the object with which the apparatus is to be used. The configuration illustrated in FIG. 5 is particularly designed for the storage and transportation of tires but it should be understood that the support may take on different forms for different objects.

Each of the end plates 68 includes two stub shafts 72 which are connected to the ends of the links 64 remote from the pivot pins 62. As can be seen from both FIGS. 2 and 3, the location of the stub shafts for the cradles 20 is somewhat different then the location for the stub shafts 72 utilized with the cradles 22. Moreover, the cradles 22 which, it will recalled are connected into the apparatus by the intermediate length links 64 are somewhat shorter, end to end, than the cradles 20, which are connected to the apparatus by the relatively long links 60.

From the foregoing, it will be appreciated that the end plates 68 for the cradles 20 and 22 form a second set of short links for each of the linkages 28 and 30 to complete the eight parallelogram linkages 28 and 30. The result is an apparatus wherein all of the cradles 20, 22 may be moved to a position such as shown in FIG. 2 above and overlying the frame 32. In this situation, the cradles 20 will be resting on the upper, relatively high support surfaces 46 for support while the lower cradles 22 will fit under the upper cradles 20 and rest on the upper support surfaces 40 of the stringers 38. The ultimate length of the links 60 and 64 is chosen so that the lower cradles 22 may be moved between a position substantially resting on the underlying terrain as shown in the left side of FIG. 3 to a position overlying the frame and resting on the support surface 40 of the frame 32 as illustrated in the right hand side of FIG. 3 and in FIG. 2. The cradles 20 may be moved from a position substantially resting on the underlying terrain as illustrated in the right hand side of FIG. 3 to a position overlying the frame 32 and resting on the support surfaces 46 as illustrated on the left side of FIG. 3 and in FIG. 2. As alluded to earlier, the cradles 22 are slightly shorter than the cradles 20 so that first linkages 28 are outermost on the frame 32 with the second linkages 30 being innermost, thereby avoiding any possible interference between the cradles on the same side of frame 68 or 32 during movement of the cradles between the two positions.

As seen in FIG. 3, an extendable motor 76 in the form of a fluid cylinder, preferably a hydraulic cylinder, is interconnected between opposite ones of the pivot pins 62 and stub shafts 72 for each of the eight linkages 28, 30. The cylinder 76 is located between the legs of the channel forming the links 60 and consequently, will be substantially housed by the channels when the cradles 20 are in their position overlying the frame. Extendable motors, again, preferably fluid motors, and even more preferably, hydraulic cylinders 78 similarly interconnects one of the pivots 62 and an opposite one of the stub shafts 72 on the ends of the lower cradles 22. The cylinders 78 will likewise be housed by the channels defining the intermediate length links of 64 when the lower cradles 22 are placed in a position overlying the frame 16, 32. There are a total of four of the hydraulic cylinders 76 and four of the hydraulic cylinders 78 employed, one for each of the linkages each of the first linkages 28 and one of the second linkages 30. Conventional controls can be employed and typically counterbalance valves (not shown) are used to control the over center positioning of the cradles 20 and 22 which is evident comparison of their respective extreme positions as seen in FIG. 3.

As a result of the foregoing, objects such as tires may be stored in significant numbers in the cradles 20, 22 as well as transported as desired. The hydraulic cylinders 76, 78 provide for powered movement of the cradles 20, 22 to a lower position so that heavy tires and wheel combinations or simply tires alone may be more easily handled by the operator of the vehicle at a point of use.

Thus, the apparatus of the invention when provided with a transportation mode is ideally suited for moving a large quantity of tires between location or moving a variety of different size tires to a point where another vehicle requires tire replacement. Moreover, even without the transportation mode, the apparatus provides an ideal means of storing large quantities of objects such as tires while eliminating much of the labor of handling such tires and moving them from an elevated storage position to a position where they can be easily accessed and moved to a point of use.

1. A transporter and storage unit comprising:
an elongated vehicle frame having a front and a rear interconnected by elongated opposite sides;
ground engaging means on said frame whereby said frame may traverse the underlying terrain;
at least two movable elongated object supports extending forwardly from said rear on at least one of said sides above said frame, said object supports being movable between positions overlying said frame and positions substantially engaging the underlying terrain;
a pair of parallelogram linkages for each of said object supports, each having long links and short links, and having pivots at corresponding ends of said links and interconnecting the same;
a first two of said pivots of each linkage of each pair being pivoted to a part of said frame defining one of said short links or to a short link joined to said frame, said first two pivots for the linkages of each pair being aligned with one another; and
a second two of said pivots of each linkage of each pair being pivoted to a part of a corresponding one of said object supports defining a second one of said short links or to a short link joined to said object support, said second two pivots for the linkages of each pair being aligned with one another.

2. The transporter and storage unit of claim 1 wherein both said object supports are located to the same side of said frame and the long links of one of said pairs are longer than the long links of the other of said pairs.

3. The transporter and storage unit of claim 1 wherein one of said object supports is located to one of said opposite sides and the other of said object supports is located to the other of said opposite sides.

4. The transporter and storage unit of claim 1 further included extendible motors, one for each linkage, extending generally between opposite ones of one of said first two pivots and one of said second two pivots.

5. The transporter and storage unit of claim 1 further including object support rests on said frame engageable by said object supports when said object supports are in a position overlying said frame.

6. The transporter and storage unit of claim 1 wherein there are four said object supports, two located to one of said opposite sides and two located to the other of said opposite sides.

7. The transporter and storage unit of claim 6 wherein the two object supports on each of said sides are vertically separated, one being higher on said frame than the other when both are in said position overlying said frame.

8. The transporter and storage unit of claim 7 wherein lowermost ones of said object supports are shorter than uppermost ones of said object supports and each said pair of linkages includes a linkage located at each end of the corresponding object support, said first two pivots of one linkage being shared by the other linkage at the corresponding ends of the object supports located to the same opposite side of said frame.

9. The transporter and storage unit of claim 8 where the long links of the pair of linkages connected to the uppermost object support when the object supports are overlying said frame are longer than the long links of the pair of linkages connected to the lowermost object support when the object supports are overlying said frame.

10. The transporter and storage unit of claim 9 wherein there is an extendible fluid motor interconnecting two opposite corners of each said linkage.

11. The transporter and storage unit of claim 1 wherein each object support includes an end plate at each end thereof and each said end plate defines a short link to which said second two pivots are attached.

12. The transporter and storage unit of claim 11 wherein each said object support includes a plurality of bars extending between its end plates and defining a support for articles to be transported or stored.

13. A transporter and storage unit comprising:
an elongated vehicle frame having a front and rear interconnected by elongated opposite sides;
ground engaging means on said frame whereby said frame may traverse the underlying terrain;
two movable elongated cradles extending forwardly from said rear on each of said sides above said frame, said cradles being movable between positions overlying said frame with one cradle on each side additionally overlying the other cradle on the same side, and positions substantially engaging the underlying terrain;
a pair of parallelogram linkages for each of said cradles, each having long links and short links, and having pivots at corresponding ends of said links and interconnecting the same;
the long links for said one cradles being longer than the long links for said other cradles;
a first two of said pivots of each linkage of each pair being pivoted to a part of said frame defining one of said short links or to a short link joined to said frame, said first two pivots for the linkages of each pair being aligned with one another; and
a second two of said pivots of each linkage of each pair being pivoted to a part of a corresponding one of said cradles defining a second one of said short links or to a short link joined to said cradle, said second two pivots for the linkages of each pair being aligned with one another.

14. The transporter and storage unit of claim 13 wherein said first two pivots of one linkage on each side of said frame are shared by the other linkage on the same side of said frame at the corresponding ends of said frame.

15. The transporter and storage unit of claim 13 wherein said long links of each linkage are formed of channels opening toward each other and further including extendible motors, one for each linkage, extending generally between opposite ones of one of said first two pivots and one of said second two pivots.

16. Apparatus comprising:
a frame including two spaced cross members connected to one another by at least one elongated stringer, said elongated stringer(s) having an upper, relatively low, support surface;
a generally centrally located upright element extending upwardly from each of said cross member and terminating in an upper, relatively high support surface;
a plurality parallelogram linkages, each having two relatively short links with four first linkages having relatively long links and four second linkages having intermediate length links to respectively provide four linkages having said relatively long links connected by pivots at their ends to said relatively short links and four linkages having said intermediate length links connected by pivots to said relatively short links to respectively form said first and second linkages;
each of said cross members mounting one of said first linkages and one of said second linkages on each side of said upright element at one of said relatively short links with said first linkages being outermost and said second linkages being innermost;
four cradles each having spaced end plates interconnected by at least one support member, said end plates each defining one of said relatively short links;
stub shafts extending from said end plates to define those of said pivots connecting said relatively long links and said intermediate length links to the short links defined by said end plates;
said relatively long links having lengths such that cradles mounted to said first linkages are movable between positions substantially engaged with terrain underlying said frame and resting on said relatively high support surfaces;
said intermediate length links having a length so that cradles mounted to said second linkages are movable between positions substantially engaged with terrain underlying said frame and resting on said relatively low support surface; and
motors for independently moving said cradles between said positions.

17. The apparatus of claim 16 wherein said relatively long links and intermediate length links are formed of channels which open toward each other and said motors are fluid cylinders extending between opposite ones of said pivots in each linkage, said cylinders being housed by said channels when the corresponding cradle is resting on its support surface.

18. The apparatus of claim 16 wherein each said at least one support member comprises a plurality a generally parallel, spaced bars interconnecting the associated end plates.
